(19) United States
(12) Patent Application Publication
(10) Pub. No.: US 2024/0109777 A1
(43) Pub. Date: Apr. 4, 2024

(54) METHOD FOR MAKING HIGH FIGURE-OF-MERIT NANOSTRUCTURED THERMOELECTRIC MATERIALS

(71) Applicant: Indian Institute of Science Education and Research, Pune (IISER Pune), Pashan (IN)

(72) Inventors: Navita JAKHAR, Pashan (IN); Surjeet SINGH, Pashan (IN)

(21) Appl. No.: 18/127,941

(22) Filed: Mar. 29, 2023

(30) Foreign Application Priority Data
Mar. 29, 2022 (IN) 202221018408

(51) Int. Cl. C01B 19/00

(52) U.S. Cl. CPC C01B 19/007; C01P 2002/72; C01P 2004/03; C01P 2004/04; C01P 2004/30; C01P 2004/64; C01P 2006/10; C01P 2006/32; C01P 2006/40

(57) ABSTRACT

The present disclosure generally relates to an all room-temperature, cost effective and highly-reproducible method for producing phase-pure nanostructured Ag2Te pellets that does not require spark-plasma sintering or high-temperature vacuum furnaces, while produces bulk and dense pellet materials with superior thermoelectric properties.

### PRIORITY CLAIM

This application claims priority to Indian application serial no. IN 202221018408, filed Mar. 29, 2022. This and all other referenced extrinsic materials are incorporated herein by reference in their entirety. Where a definition or use of a term in a reference that is incorporated by reference is inconsistent or contrary to the definition of that term provided herein, the definition or use of that term provided herein is deemed to be controlling.

### FIELD OF THE INVENTION

The present invention generally relates to the field of thermoelectrics. Specifically, relates to an all-room-temperature synthesis and fabrication method for producing high-density pellets of thermoelectric material silver telluride (Ag2Te) with thermoelectric figure of merit (zT) exceeding 1.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

Thermoelectrics materials are useful in converting waste heat into clean energy. The utility of a thermoelectric (TE) material is determined by several factors, including: (i) the dimensionless TE figure-of-merit (zT) which should be large (preferably greater than 1) for any practical application, and (ii) high-density and strength for device fabrication. Ag2Te is a candidate thermoelectric material for near room-temperature applications.

The currently used TE materials for near room-temperature applications, for example, PbTe, Bi2Te3, etc., require several complex processing steps to get the desired TE figure of merit (zT) in the range of 1 to 1.5. Their synthesis generally involves chemical or mechanical routes. The chemical synthesis suffers from low-yield, and mechanical synthesis involve high-energy planetary ball-milling. The nanopowder in either case should be consolidated either using high-temperature hot-pressing (HP) or spark plasma sintering (SPS) to get the desired high density and zT.

Some TEs can be prepared by direct melting of the constituent at high-temperatures under vacuum to get a solidified ingot. However, such ingots are typically brittle and they also lack reproducibility due to evaporative losses. Thus, all the existing methods for preparing TE materials as high-density pellets are rather involved, time consuming and have high synthesis cost, and require use of expensive instruments. In the case of TE Ag2Te, high-temperature synthesis is particularly not useful as it results in irreproducible results due to the superionic nature of Ag ions.

Further, the previously reported methods for fabricating high-density samples of Ag2Te involve: melting the precursors in an evacuated silica tube at high-temperature (method 1), or by hot-pressing or spark-plasma-sintering of chemically or mechanically synthesized nanoparticles of Ag2Te (method 2). Both these methods involve use of high-temperatures, incur considerable processing cost and time, and the properties of processed material are not reproducible due to migration of superionic Ag during high-temperature synthesis.

Also, the existing methods of synthesizing high-density samples of Ag2Te involve use of high-temperature furnaces or hot-pressing (HP) or spark plasma sintering (SPS) to achieve high density. However, at high-temperatures (above 600 K), an indeterminate but small fraction of Ag ions migrate out of the sample due to their superionic behavior, which results in sample dependent TE properties. The difference from sample to sample due to migratory nature of Ag-ions, which results in self-doping, can even change the behavior from n-_type to p-type. The absence of nanostructuring in these samples also deteriorate the zT considerably.

In previously reported synthesis methods, including solid-state melting by J. Capps et al [Philosophical Magazine Letters Vol. 90, No. 9, September 2010, 677-681], required use of high temperature furnace and vacuum processing which is costly, time consuming and non-effective since the maximum zT with this method is only 0.64 at 575 K. Synthesis of nanowires and nanoparticles by Y. Chang et al. [CrystEngComm, 2019, 21,1718] and D. Cadavid et al. [J. Mater. Chem. A, 2012], requires chemical synthesis followed by spark-plasma sintering for densification. But even then, the resulting samples had a low density (about 75% of the theoretical density) with pores formation while densifying. This method is also time consuming, requires use of costly equipment, and ineffective as the density of samples produced is not high-enough for device fabrication. Hand-milling followed by cold-pressing is an alternative method previously reported by T. Xinfeng et al. (Chinese patent CN109384202A). However, the hand-grinded powders consist of large grain and hence nanostructuring, which is essential for lowering the lattice thermal conductivity, cannot be adopted.

The current method is an all-room-temperature method where the entire processing is done at room-temperature in two steps. The complete process takes less less than 4 h. In the current method the stoichiometry can be accurately maintained due to absence of migratory Ag losses. The TE properties therefore do not vary from one sample to the other. Due to high-density, the resultant Ag2Te pellets of the present invention have a superior electrical behavior, and due to nanostructuring an ultralow thermal conductivity leading to zT exceeding 1.

### OBJECTS OF THE INVENTION

An object of the present invention is to provide a synthesis and fabrication method for producing high-density, nanostructured pellets of thermoelectric material.

An object of the present invention is to provide a synthesis and fabrication method for producing high-density, nanostructured pellets of thermoelectric material.

An object of the present invention is to provide an all-room-temperature synthesis and fabrication method for producing high-density, nanostructured pellets of thermoelectric material silver telluride (Ag2Te).

An object of the present invention is to provide an all-room-temperature synthesis and fabrication method for producing high-density nanostructured pellets of thermoelectric material silver telluride (Ag2Te) from silver and tellurium powders.

An object of the present invention is to provide a one-pot, all-room-temperature synthesis and fabrication method for producing high-density nanostructured pellets of thermoelectric material silver telluride (Ag2Te) from silver and tellurium powders.

An object of the present invention is to provide a one-pot, all-room-temperature synthesis and fabrication method for producing high-density nanostructured pellets of thermoelectric material silver telluride (Ag2Te) from silver and tellurium powders that does not require vacuum heating or spark-plasma sintering.

Another object of the present invention is to provide a one-pot, all-room-temperature synthesis and fabrication method for producing high-density nanostructured pellets of thermoelectric material silver telluride (Ag2Te) from silver and tellurium powders for clean energy generation.

Yet another object of the present invention is to provide a one-pot, all-room-temperature synthesis and fabrication method for producing high-density nanostructured pellets of thermoelectric material silver telluride (Ag2Te), wherein the pellets exhibit a high zT of 1.2 near 600 K and 0.6 near 300 K which makes them suitable for near-room temperature energy harvesting applications.

### SUMMARY OF THE INVENTION

This summary is provided to introduce a selection of concepts in a simplified form that are further described below in Detailed Description section. This summary is not intended to identify key features or essential features of the claimed subject matter, nor is it intended to be used as an aid in determining the scope of the claimed subject matter.

In an aspect, the present invention relates to a synthesis and fabrication method for producing high-density pellets of thermoelectric material.

In an aspect, the present invention relates to a synthesis and fabrication method for producing high-density pellets of thermoelectric material.

In an aspect, the present invention relates to an all-room-temperature synthesis and fabrication method for producing high-density pellets of thermoelectric material silver telluride (Ag2Te).

In an aspect, the present invention relates to an all-room-temperature synthesis and fabrication method for producing high-density pellets of thermoelectric material silver telluride (Ag2Te) from silver and tellurium nanoparticles.

In an aspect, the present invention relates to a one-pot, all-room-temperature synthesis and fabrication method for producing high-density pellets of thermoelectric material silver telluride (Ag2Te) from silver and tellurium nanoparticles.

In an aspect, the present invention relates to a one-pot, all-room-temperature synthesis and fabrication method for producing high-density pellets of thermoelectric material silver telluride (Ag2Te) from silver and tellurium nanoparticles that does not require vacuum heating or spark-plasma sintering.

In another aspect, the present invention relates to a one-pot, all-room-temperature synthesis and fabrication method for producing high-density pellets of thermoelectric material silver telluride (Ag2Te) from silver and tellurium nanoparticles for clean energy generation.

In yet another aspect, the present invention relates to a one-pot, all-room-temperature synthesis and fabrication method for producing high-density pellets of thermoelectric material silver telluride (Ag2Te), wherein the pellets exhibit a high zT of 1.2 near 600 K and 0.6 near 300 K which makes them suitable for near-room temperature applications.

Other aspects of the invention will be set forth in the description which follows, and in part will be apparent from the description, or may be learnt by the practice of the invention.

### BRIEF DESCRIPTION OF DRAWINGS OF THE INVENTION

The following drawings form part of the present specification and are included to further illustrate aspects of the present disclosure. The disclosure may be better understood by reference to the drawings in combination with the detailed description of the specific embodiments presented herein.

FIG. 1 represents powder x-ray diffraction patterns of the samples prepared by three different methods, namely: solid-state melting, ball-milling, and hand grinding. Simulation for the monoclinic P21/c space group is also shown for comparison.

FIG. 2 represents transmission electron microscopy images to illustrate the particle-size and particle-shape variations of our ball-milled samples to obtain all-scale hierarchical approach used for suppressing the lattice thermal conductivity. In panel (a) low-resolution image is shown to illustrate the particle-size distribution. Panels (b) to (f) show high-resolution images showing various particle geometries obtained in our ball-milled samples.

FIG. 3 represents temperature dependence of (a) electrical conductivity (σ), (b) Seebeck coefficient (S), (c) thermal conductivity (κ), and (d) figure-of-merit (zT) of four different Ag2Te samples prepared using our invention. The milling time is 200 min (AT1), 400 min (AT2), 500 min (AT3), and 600 min (AT4).

FIG. 4 represents scanning electron microscopy images. Panel (a) FESEM image at 200 nm, (b) high resolution TEM image at 5 nm showing microstructure of the cold-pressed sample, (c) and (d) are the histograms for grain size distribution in FESEM image and HRTEM image respectively.

FIG. 5 represents powder x-ray diffraction for the samples AT1, AT2, AT3, and AT4 in panel (a) whose thermoelectrics properties are shown in FIG. 3. In panel (b), a zoom-in view for the −212 diffraction peak is shown. The inset in (b) shows the FWHM as a function of milling time.

FIG. 6(a) represents the graphical interpretation of zT variation of Ag2Te samples produced by (i) by solid-state melting, (ii) by hand milling followed by cold-pressing, and (iii) by hand milling followed by cold-pressing, and zT variation of Ag2Te samples reported in the previous studies. Color code: solid-state melting or ingot (black), Ball milling followed cold-pressing (red), Hand-grinding followed by cold-pressing (blue), Capps. et al. (pink) [Philosophical Magazine Letters Vol. 90, No. 9, September 2010, 677-681] where solid state melting method was used, Xinfeng et al. (green) from Chinese patent CN109384202A where hand-grinding followed by cold-pressing method was used. (b) represents zTₘₐₓ (i.e., the peak zT at 570 K) for various samples (present work and previous studies for comparison). zT_{avg} is the average zT over the temperature range 300 K to 570 K.

### DETAILED DESCRIPTION OF THE INVENTION

The following is a detailed description of embodiments of the disclosure. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some embodiments, numbers have been used for quantifying weight percentages, angles, and so forth, to describe and claim certain embodiments of the invention and are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Various terms as used herein are shown below. To the extent a term used in a claim is not defined below, it should be given the broadest definition persons in the pertinent art have given that term as reflected in printed publications and issued patents at the time of filing.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context requires otherwise, throughout the specification which follow, the word “comprise” and variations thereof, such as, “comprises” and “comprising” are to be construed in an open, inclusive sense that is as “including, but not limited to.”

The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified.

The description that follows, and the embodiments described therein, is provided by way of illustration of an example, or examples, of particular embodiments of the principles and aspects of the present disclosure. These examples are provided for the purposes of explanation, and not of limitation, of those principles and of the disclosure.

The headings and abstract of the invention provided herein are for convenience only and do not interpret the scope or meaning of the embodiments.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As described herein, the term “thermoelectric material” has the meaning known in the state of the art. The term denotes materials are useful in scavenging waste heat and converting it into clean energy.

While a particular form of the invention has been illustrated and described, it will be apparent that various modifications can be made without departing from the spirit and scope of the invention.

The present disclosure generally relates to an all-room-temperature synthesis and fabrication method for producing high-density pellets of thermoelectric material.

In one embodiment, the present invention relates to a cost-effective and non-toxic, thermoelectric material with high thermoelectric figure of merit

In one embodiment, the present invention relates to methods of fabricating a thermoelectric material. In such a method, a plurality of nanoparticles is generated from a thermoelectric material. The nanoparticles can be consolidated under pressure at an elevated temperature to form the thermoelectric material. The types of thermoelectric starting materials that can be utilized to generate the nanoparticles include, without limitation, any of the bulk materials disclosed herein, and others known to those skilled in the art. Accordingly, embodiments can include thermoelectric materials having a ZT value greater than about 1 (e.g., at a temperature below about 2000° C.). In addition or alternatively, the methods can utilize starting materials (e.g., bulk thermoelectrics which are elemental and/or alloys) that are n-doped or p-doped.

In an embodiment of the present invention, a variety of thermoelectric materials can be used as the starting material including but not limited to antimony-based, germanium-based, selenium-based, silver-based, bismuth-based, lead-based, silicon-based materials, and the like. Preferably silver-based ensemble materials.

In an embodiment of the present invention, the pellets can be generated from the mixing of two or more thermoelectric nanoparticle materials.

In an embodiment of the present invention, nanoparticles can be generated from the thermoelectric ensemble materials including but not limited to bismuth-telluride material systems, silver-telluride material systems, lead-telluride material systems, silicon-germanium material systems, and the like. Most preferably silver telluride material.

In an embodiment of the present invention, nanoparticles can have sizes ranging from about 1 nm to about 1000 nm, sizes ranging from about 1 nm to about 700 nm, sizes ranging from about 1 nm to about 500 nm, ranging from about 1 nm to about 200 nm, sizes ranging from about 1 nm to about 100 nm, and preferably in a range of about 1 nm to about 50 nm, and most preferably in a range of about 3 nm to about 10 nm.

In another embodiment, the present invention relates to an all-room-temperature method where the entire processing is done at room-temperature.

In another embodiment, the present invention relates to all-room-temperature synthesis and fabrication of high-density pellets of Ag2Te nanoparticles comprising the steps of:
a) providing Silver (Ag) and Tellurium (Te) powders;
b) loading of Ag and Te powders in a stainless-steel capsule/bead of appropriate diameter under inert gas atmosphere;
c) milling of Ag and Te powders in a vibration mill for 3 h-5 h at a low-frequency to obtain nanoparticles;
d) consolidation of the synthesized Ag2Te nanoparticle powders at room-temperature in a press die to obtain high density pellets of Ag2Te nanoparticles.

In an embodiment of the present invention, the method is a one pot synthesis method.

In an embodiment of the present invention, the Ag powder is provided in an amount of 60-65% wt. with respect to the combined weight of Ag and Te Powders. For example, 60% wt., 60.5% wt., 61% wt., 61.5% wt., 62% wt., 62.5% wt., 63% wt., 63.5% wt., 64% wt., 64.5% wt., or 65% wt.

In an embodiment of the present invention, the Te powder is provided in an amount of 35-40% wt. with respect to the combined weight of Ag and Te Powders. For example, 35% wt., 35.5% wt., 36% wt., 36.5% wt., 37% wt., 37.5% wt., 38% wt., 38.5% wt., 39% wt., 39.5% wt., or 40% wt.

In an embodiment of the present invention, the stoichiometric ratio of Ag and Te powders is 2:1 and the Ag and Te powders are weighed with an accuracy better than 1 □g.

In an embodiment of the present invention, the sample to balls ratio used is 1:2.4.

In an embodiment of the present invention, the inert gas atmosphere is an inert atmosphere of argon gas.

In an embodiment of the present invention, the room temperature ranges from about 25 deg C. to about 40 deg C.

In an embodiment of the present invention, the low frequency in step c) ranges from 1 Hz to 10 Hz. For example 1 Hz, 2 Hz, 3 Hz, 4 Hz, 5 Hz, 6 Hz, 7 Hz, 8 Hz, 9 Hz, or 10 Hz. Preferably 2 Hz.

In an embodiment of the present invention, the consolidation is effected in an 8 mm die set under 3-ton pressure for 5 minutes.

In an embodiment of the present invention, the density of the pellets can be in a range from about 90% to about 100% of the respective theoretical density. Most preferably 99.99%.

In an embodiment of the present invention, the pellets exhibit a porosity ranging from less than about 10% to about 0.1%.

In an embodiment of the present invention, the pellets exhibit a thermoelectric figure-of-merit (zT) value can be greater than about 0.6, or greater than about 0.7, or greater than about 0.8, or greater than about 0.9 or greater than about 1.0, or greater than about 1.1, or greater than about 1.2 at 600 K. Preferably greater than about 1.0 at 600 K. Most preferably 1.2 at 570-600 K.

In an embodiment of the present invention, the pellets can be used in clean energy generation systems, insulation systems, sensors, and the like.

While the foregoing describes various embodiments of the disclosure, other and further embodiments of the disclosure may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

In an embodiment, the pharmaceutical composition of the present invention may be used in any manner known to a person skilled in the art.

### EXAMPLES

The present disclosure is further explained in the form of following examples. However, it is to be understood that the foregoing examples are merely illustrative and are not to be taken as limitations upon the scope of the invention. Various changes and modifications to the disclosed embodiments will be apparent to those skilled in the art. Such changes and modifications may be made without departing from the scope of the invention.

### Example 1: Ag2Te Nanoparticle Production

TABLE 1
Materials

| Precursors used | Source | Purity | Quantity | Color and form |
|---|---|---|---|---|
| Ag | sigma Aldrich | 99.9% | 1.257 g | gray, powder |
| Te | sigma Aldrich | 99.99% | 0.7434 g | black, powder |

In the first step, Ag2Te nanoparticles were synthesized using room temperature one pot synthesis method. For this, stoichiometric amounts of Ag (Sigma Aldrich, 99.9% purity) and Te (Sigma Aldrich, 99.99% purity) powders are loaded in a stainless-steel capsule (SS) along with 9 SS balls under Ar atmosphere. The volume of SS capsule was homemade. It had a volume 6 cm⁻³ with an air-tight lid. Each SS bead had a diameter of 0.4 cm. The sample to balls ratio used was 1:2.4. The synthesis was carried out by shaking the loaded capsule at 2 Hz for (a) 200 min (AT1), (b) 400 min, (c) 500 min, and (d) 600 min in a vibration mill (Technosearch Instruments, Mumbai). There were no losses during the synthesis process and the method yielded exactly the same quantity of Ag2Te as combined weight of two precursors initially taken.

In the second step, the obtained nanoparticles were consolidated using a KBr press die set into 8 mm pallets. The sample mass density was estimated by using the Archimedes method where 99.8% pure ethanol was used to estimate the buoyancy force. The cold-pressing of the nanoparticles yielded 100% dense samples which can be attributed to small particle size (5-10 nm) and high malleability of Ag2Te.

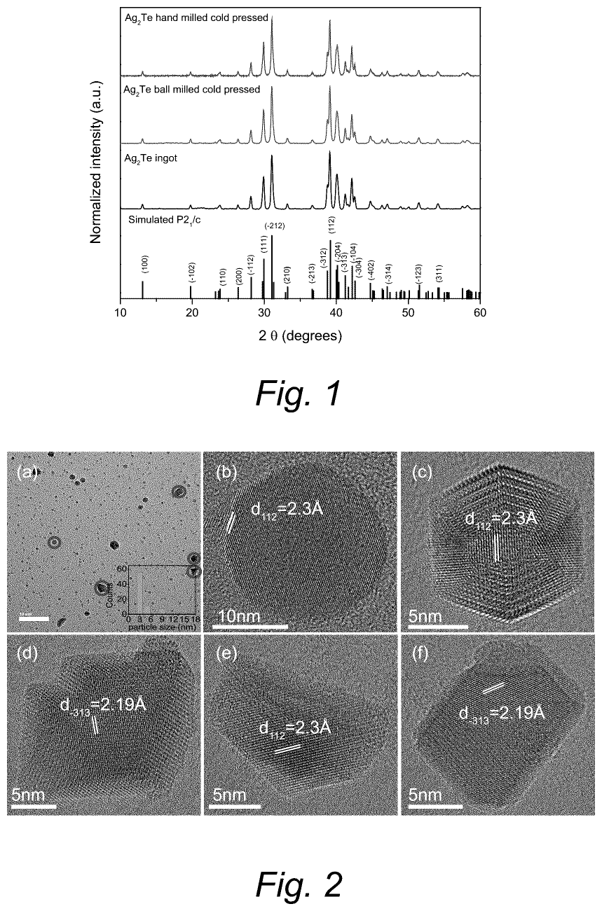

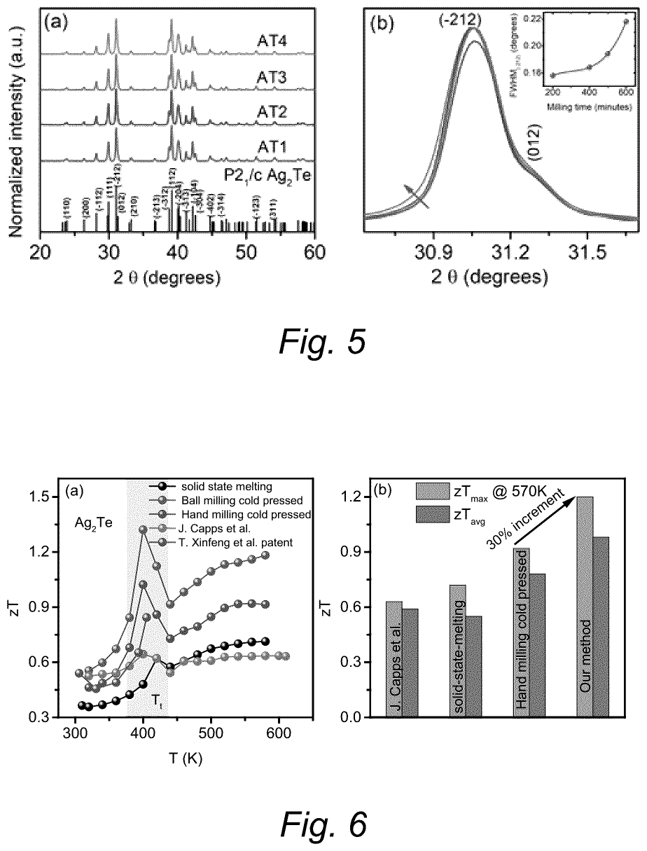

For comparison, two more Ag2Te samples were prepared: (i) by solid-state melting, (ii) by hand milling followed by cold-pressing. Total 3 g quantity of samples was synthesized using solid-state-melting method. Stoichiometric amounts of Ag and Te powders were weighted and transferred into preheated quartz ampule containing alumina crucible inside the glove box. Ampule was vacuum sealed under 9×10⁻⁵ Torr pressure and heated up to 1000° C. in a box furnace in 10 h. After waiting at this temperature for 5 h, the melt was cooled to 500° C. in 50 h. The furnace was then turned off and sample was allowed to cool down to room temperature where it was removed by breaking the ampoule. The Ag2Te ingot thus obtained was cut into appropriate shapes to perform the thermoelectric properties measurements. For the hand milled sample, a total 1 g sample quantity was synthesized. The stoichiometric quantities of Ag and Te powders were weighted inside a glove box. These powders were mixed and hand grinded inside the glove box for 2.5 h. After this, we confirmed the phase purity using the powder x-ray diffraction (FIG. 1 and FIG. 5). The obtained Ag2Te powders were then cold pressed in the form of 8 mm pellets using a KBr press die set. Samples for transport measurements were cut from 8 mm cold pressed pellets and analyzed by transmission electron microscopy (TEM) (FIG. 2) and FESEM and HRTEM (FIG. 4). This method was previously reported in the Chinese patent by T. Xinfeng et al. CN109384202A.

### Example 2: Ag2Te Thermoelectric Properties

Pellets from Example 1 were cut using a low-speed diamond saw into bar shaped samples to measure the electrical conductivity (a) and thermopower (α) using the LSR 3 setup commercially (LINSEIS Germany). The measurements are done from room temperature to 600 K during cooling and re-heating. The average uncertainties in these measurements are less than 5%. Thermal diffusivity (D) measurement was performed using LFA 1000 setup (LINSEIS Germany) directly on the 8 mm pellet samples from room temperature to 600 K. The average uncertainty in thermal diffusivity using this setup is near 5%. The specific heat (cp) near room-temperature was measured using a Physical Property Measurement System (Quantum Design, USA). The thermal conductivity (k) is the obtained using the formula k=D.cₚ.ρₘ. Using measured σ, k, and α, the zT is obtained using the formula: zT=σα²/k. The maximum uncertainty in zT is less than 15%.

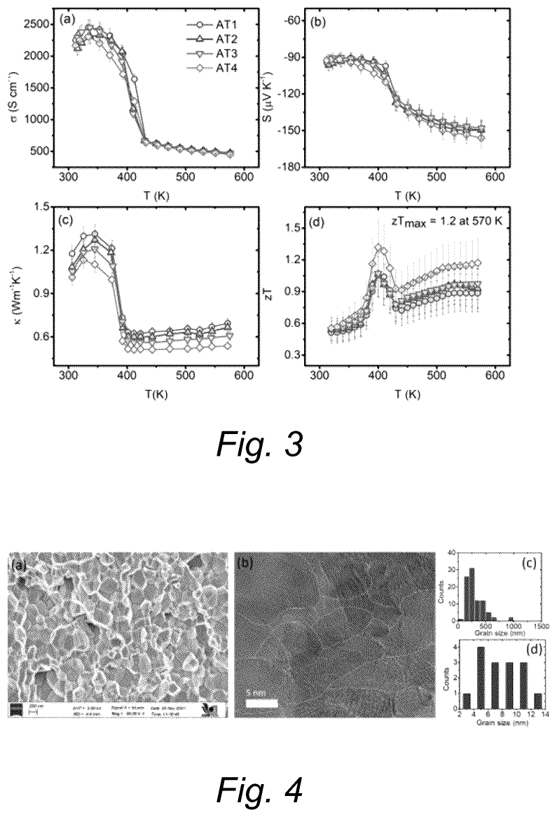

The measured zT for several samples made using Example 1 is shown in FIG. 3 and FIG. 6. Within the error bars of our measurement the sample prepared in the present invention exhibit the highest zT with a zT of 0.9 near 450 K which increases to 1.2 near 570 K. Above 600 K temperature, the Ag ions tends to diffuse out; 600 K is therefore the highest temperature up to which this material can be used successfully. For comparison, we have also included zT variation of Ag2Te samples reported in the previous study. These values represent significant improvement over the values previously reported or the values of zT obtained using the previously reported or patented methods as show in FIG. 6.

### Advantages of the Present Invention

The present disclosure provides a method for producing high-density pellets of thermoelectric material silver telluride (Ag2Te) that is an all-room-temperature method.

The present disclosure provides a method for producing high-density pellets of thermoelectric Ag2Te that does not require vacuum heating or spark-plasma sintering.

The method prevents the migratory Ag losses, and hence the stoichiometry of our samples remains constant and does not vary from one sample to the other.

Due to high-density, the high-density pellets of thermoelectric Ag2Te have a superior electrical behavior.

Due to nanostructuring, high-density pellets of thermoelectric Ag2Te have an ultralow thermal conductivity.

The mass density of high-density pellets of thermoelectric Ag2Te samples produced is almost 100% of the theoretical density since no pores are present.

The processing time for producing high-density pellets of thermoelectric Ag2Te from beginning to end is less than 4 h.

The high-density pellets of thermoelectric Ag2Te samples exhibit a high zT of 1.2 near 570-600 K which makes them suitable for near-room temperature applications.

The high-density pellets of thermoelectric Ag2Te are non-toxic.

We claim:

1. A high-density nanostructured pellet of thermoelectric material suitable for near-room temperature applications. The said pellet comprises Ag2Te nanoparticles having a thermoelectric figure-of-merit (zT) greater than 1 near 600 K.

2. The pellet as claimed in claim 1, wherein the high-density Ag2Te pellets exhibit a particle size of 5 nm to 1 □m.

3. The pellet as claimed in claim 1, wherein the high-density Ag2Te pellets exhibit a thermoelectric figure-of-merit (zT) of 1.2 near 570-600 K.

4. The pellet as claimed in claim 1, wherein the high-density Ag2Te pellets exhibit a density of 98% to 100% of the respective theoretical density.

5. The pellet as claimed in claim 1, wherein the high-density Ag2Te pellets exhibit a porosity ranging from less than about 2% to about 0.1%.

6. A method for an all-room-temperature synthesis and fabrication of high-density pellets of silver telluride (Ag2Te) nanoparticles as claimed in claim 1, said method comprises the steps of:
a) providing Silver (Ag) and Tellurium (Te) powders;
b) loading of Ag and Te powders in a stainless-steel container under inert gas atmosphere along with stainless-steel balls;
c) milling of Ag and Te powders in a vibration mill for 3-5 h at a low-frequency to obtain Ag2Te nanoparticle nanoparticle powders;
d) consolidation of the synthesized Ag2Te nanoparticle powders at a temperature of 25 deg C. to 40 deg C. in a cold-press die to obtain high density pellets of Ag2Te nanoparticles.

7. The method as claimed in claim 1, wherein the stoichiometric ratio of Ag and Te powders is 2:1 and the Ag and Te powders are weighed with an accuracy better than 1 ≡g.

8. The method as claimed in claim 1, wherein the sample to balls ratio used is 1:2.4.

9. The method as claimed in claim 1, wherein the inert gas atmosphere is an inert atmosphere of argon gas.

10. The method as claimed in claim 1, wherein the low frequency in step c) is 2 Hz.

11. The method as claimed in claim 1, wherein the consolidation is effected in an 8 mm die set under 3-ton pressure for 5 minutes.

12. The method as claimed in claim 1, wherein the method yields the same quantity of pellets of Ag2Te nanoparticles as combined weight of Ag and Te in step a).
